(19) United States
(12) Patent Application Publication
(10) Pub. No.: US 2023/0186217 A1
(43) Pub. Date: Jun. 15, 2023

(54) DYNAMICALLY ENHANCING SUPPLY CHAIN STRATEGIES BASED ON CARBON EMISSION TARGETS

(71) Applicant: International Business Machines Corporation, Armonk, NY (US)

(72) Inventors: Kedar Kulkarni, Bangalore (IN); Reginald Eugene Bryant, Naiorbi (KE); Isaac Waweru Wambugu, Nairobi (KE); Ivan Kayongo, Nairobi (KE); Smitkumar Narotambhai Marvaniya, Bangalore (IN); Komminist Weldemariam, Ottawa (CA); Shantanu R. Godbole, Bangalore (IN)

(21) Appl. No.: 17/549,214

(22) Filed: Dec. 13, 2021

(51) Int. Cl. G06Q 10/06; G06N 20/00

(52) U.S. Cl. CPC G06Q 10/0637; G06Q 10/06313; G06N 20/00

(57) ABSTRACT

Methods, systems, and computer program products for dynamically enhancing supply chain strategies based on carbon emission targets are provided herein. A computer-implemented method includes obtaining enterprise-related data and carbon emissions-related data associated with the enterprise; training, using at least a portion of the obtained enterprise-related data and carbon emissions-related data, at least one machine learning-based model configured for enhancing at least one of carbon emissions reduction by the enterprise and value increase for the enterprise; processing carbon emissions data attributed to the enterprise for a given temporal period using the at least one trained machine learning-based model; generating one or more enterprise-related recommendations based at least in part on results of the processing of the carbon emissions data using the at least one trained machine learning-based model; and performing one or more automated actions based at least in part on the one or more enterprise-related recommendations.

### BACKGROUND

The present application generally relates to information technology and, more particularly, to climate-related technologies. More specifically, many enterprises attempt to measure and/or reduce their carbon footprint. For example, some enterprises publish climate-related reports that include direct and indirect (e.g., supply chain-related) emissions (e.g., greenhouse gas emissions) associated with their enterprise operations, and some enterprises also publish carbon emission reduction goals. However, many such enterprises commonly face challenges in determining strategies that will enable attainment of stated carbon emission reduction goals in conjunction with other enterprise objectives and/or constraints.

### SUMMARY

In one embodiment of the present invention, techniques for dynamically enhancing supply chain strategies based on carbon emission targets are provided. An example computer-implemented method can include obtaining enterprise-related data and carbon emissions-related data associated with the enterprise and training, using at least a portion of the obtained enterprise-related data and carbon emissions-related data, at least one machine learning-based model configured for enhancing at least one of carbon emissions reduction by the enterprise and value increase for the enterprise. The method can also include processing carbon emissions data attributed to the enterprise for a given temporal period using the at least one trained machine learning-based model, generating one or more enterprise-related recommendations based at least in part on results of the processing of the carbon emissions data using the at least one trained machine learning-based model, and performing one or more automated actions based at least in part on the one or more enterprise-related recommendations.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an example embodiment of the invention;

FIG. 2 is a diagram illustrating an initiation workflow, according to an example embodiment of the invention;

FIG. 3 is a diagram illustrating an end of week workflow, according to an example embodiment of the invention;

FIG. 4 is a diagram illustrating an end of quarter workflow, according to an example embodiment of the invention;

FIG. 5 is a diagram illustrating an end of year workflow, according to an example embodiment of the invention;

FIG. 6 is a diagram illustrating a counterfactual exploration workflow, according to an example embodiment of the invention;

FIG. 7 is a flow diagram illustrating techniques according to an example embodiment of the invention;

FIG. 8 is a system diagram of an example computer system on which at least one embodiment of the invention can be implemented;

FIG. 9 depicts a cloud computing environment according to an example embodiment of the invention; and

FIG. 10 depicts abstraction model layers according to an example embodiment of the invention.

### DETAILED DESCRIPTION

As described herein, at least one embodiment includes dynamically enhancing supply chain strategies based on carbon emission targets (e.g., greenhouse gas emissions). Such an embodiment includes incorporating at least one dashboard configured to import carbon budget limits in line with a carbon emission target framework such that projections (e.g., monthly projections, yearly projections, etc.) can be made to inform one or more intervention adjustments as a function of time, operations data, and/or ongoing carbon allowance tracking. As used herein, a carbon budget refers to a pre-determined upper-limit on carbon emissions due to different processes at an enterprise-level. Carbon emissions can correspond to emissions of different greenhouse gases as defined, for example, in a greenhouse gases protocol. One or more embodiments also include generating one or more recommendations pertaining to tactical and/or operational scenarios designed to facilitate, for example, an enterprise to meet one or more carbon budget constraints. Such recommendations can be generated, for example, by solving a constrained optimization problem that minimizes the economic costs while satisfying the carbon budget constraints.

As also detailed herein, at least one embodiment can include determining (for example, at the end of a given temporal period (e.g., month, quarter, year, etc.)) which strategic, tactical and/or operational decisions had an impact on the calculated carbon emissions, as well as performing sensitivity analysis on one or more strategic, tactical and/or operational decisions using one or more machine learning models trained at least in part on historic performance data. At least one embodiment can additionally include evaluating amortized costs of strategic investments against one or more strategic, tactical and/or operational carbon reduction decisions made over a given temporal period (e.g., a several year time horizon).

Accordingly, and as further detailed herein, one or more embodiments include dynamically optimizing second order supply chain strategies to reach carbon emission targets over given time and location parameters using an automated machine learning-based feedback loop. In such an embodiment, second order supply chain strategies refer to decisions that have an indirect impact on carbon emissions across a supply chain (e.g., discounting of green products, green product advertisement campaigns, etc.). On the other hand, first order strategies would have a direct impact on the emissions (e.g., choice of transportation mode, transport distance, etc.).

Supply chain decision making hierarchy can include, by way of example, strategic decisions, tactical decisions, and/or operational decisions. By way merely of illustration, strategic decisions can include investment decisions (e.g., buying electric vehicles for transportation), decisions pertaining to location and/or capacities of production and warehousing facilities, etc. Tactical decisions can include for example, decisions pertaining to target production quantities for one or more production facilities, decisions pertaining to which markets will supply which locations, decisions pertaining to inventory policies, etc. Operational decisions can include, for example, decisions pertaining to order fulfilment, decisions pertaining to schedules of delivery vehicles, decisions pertaining to replenish inventories, decisions pertaining to discounting low-carbon products, etc.

Additionally, one or more embodiments can include incorporating considerations related to spatio-temporal carbon emissions as well as geographically driven differences in carbon emissions. Examples of spatio-temporal carbon emission considerations can include, for instance, changes in climate conditions across different locations which impact product demand within those locations, as well as changes in demand patterns due to promotions and/or discounts having an impact on carbon emissions. Examples of geographically driven differences in carbon emissions can be incorporated, for example, using one or more heatmaps which indicate overall carbon emissions across different locations and times.

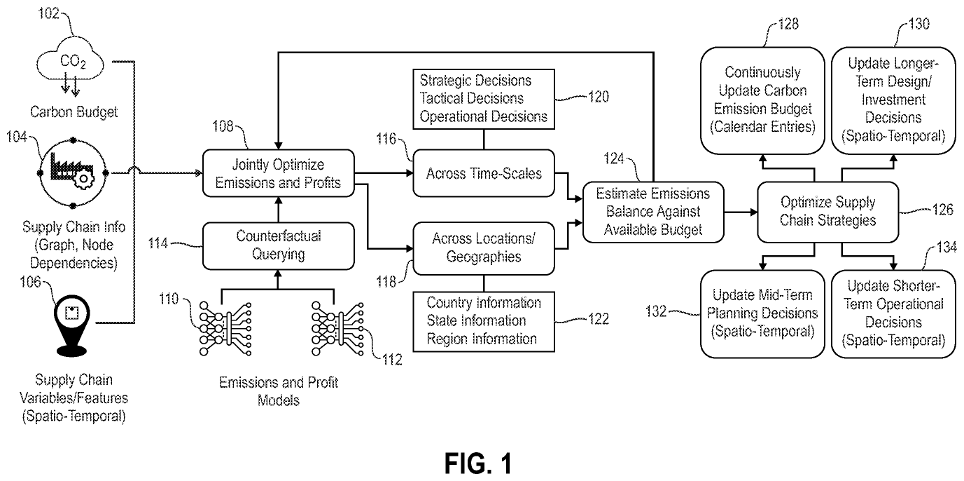

FIG. 1 is a diagram illustrating system architecture, according to an embodiment of the invention. By way of illustration, FIG. 1 depicts a carbon budget planner (CBP), which is capable of dynamically updating available carbon emissions budgets while maximizing other enterprise objectives (e.g., profits) through continuous optimization of supply chain decisions across time and space. More specifically, FIG. 1 depicts inputs including: carbon budget information 102, supply chain information (e.g., graphs, node dependencies, etc.) 104, and supply chain variables and/or features (e.g., spatio-temporal features) 106, which are processed to jointly optimize emissions and profits in step 108. Such processing can include using emissions and profit models 110 and 112, as we as counterfactual querying via step 114.

Additionally, outputs from step 108 can be further processed across time-scales in step 116 (in conjunction with decision information 120 including strategic decisions, tactical decisions, and operational decisions) and across locations and/or geographies in step 118 (in conjunction with geographic information 122 including country information, state information, region information, etc.). Based at least in part on the outputs from steps 116 and 118, at least one estimation of emissions balance against available (carbon) budget can be generated in step 124. The estimation(s) generated in step 124 can be used to train and/or update optimization techniques used in connection with subsequent instances of step 108, and can also be used to optimize supply chain strategies in step 126. Such optimized supply chain strategies can include continuously updating, in step 128, the carbon emission budget (e.g., via calendar entries), updating longer-term design and/or investment decisions (e.g., spatio-temporal decisions) in step 130, updating mid-term planning decisions (e.g., spatio-temporal decisions) in step 132, and updating shorter-term operational decisions (e.g., spatio-temporal decisions) in step 134.

By way merely of illustration, consider the following example contexts and/or embodiments as further explanation of FIG. 1. In one such example embodiment, assume a context involving CBP for an apparel retail company which subscribes to yearly emission targets for the next ten years based on help from the SBTi. Based on models trained on historical data, the example embodiment includes generating the following recommendation at the start of year one:

Long-term: Install solar panels at garment factories to meet 20% of the power needs;

Medium-term: Replace the top five environmentally unfriendly suppliers with different suppliers; and

Short-term: Stock 20% environmentally friendly products in stores (on and offline), and offer 10% discount on such products in the United States (no discount in Europe).

The company follows the long-term and short-term recommendations, but ignores the medium-term recommendation. Year one proceeds successfully, but at the end of year two, the company falls short of the emissions target by 20% (i.e., emissions are 20% higher than the target). The company runs the CBP again (such as depicted in FIG. 1), and obtains the same medium-term recommendation pertaining to its suppliers. This time, the company decides to pay heed to this recommendation. Subsequently, at the end of year three, the company exceeds the emissions target by 15% (i.e., emissions are 15% lower than the target).

Then company then runs the CBP again, and obtains similar recommendations but only for shorter-term decisions regarding order-consolidation. The company thus continues this activity for the remaining years in the time horizon and consistently reaches its yearly emission targets.

In another such example embodiment, assume a context involving CBP for an energy utility company which subscribes to yearly emission targets for the next ten years based on help from the SBTi. Based on models trained on historical data, such an example embodiment includes generating the following recommendations at the start of year one:

Long-term: Invest in wind and solar farms to generate 15% of its energy capacity;

Medium-term: Satisfy 40% of the peak load with renewable energy from wind turbines in California, and the remaining with conventional power plants in the Midwest United States; and

Short-term: Dynamically decide the optimal energy mix every week (e.g., 30% renewable and 70% non-renewable in week seven) depending on the renewable energy forecast and/or power demand.

The company ignores the long-term recommendation, but follows the medium-term and short-term recommendations. Year one proceeds successfully, but at the end of year two, the company falls short of the emissions target by 15% (i.e., emissions are 15% higher than the target). The company runs the CBP again (such as depicted in the example FIG. 1 embodiment), and obtains the same long-term recommendation about investing in renewable energy. This time, the company decides to pay heed to this recommendation, and at the end of year three, the company exceeds the emissions target by 10% (i.e., emissions are 10% lower than the target).

Subsequently, the company runs the CBP again and obtains similar recommendations but only for shorter-term decisions regarding energy mix optimization. The company thus continues this activity for the remaining years in the time horizon and consistently reaches its yearly emission targets.

Accordingly, in light of the FIG. 1 embodiment and the illustrative example embodiments detailed above, one or more embodiments include generating and continuously updating an optimal allowable carbon emission budget (e.g., via calendar entries) to be followed by each entity in a supply chain. Also, the optimal emission budget can vary as a function of space (i.e., location) and time (weekly, quarterly, yearly, etc.). At least one embodiment also includes propagating the carbon impact of decisions made at different time-scales and different locations in the supply chain on the allowable emission budget of the given enterprise. For example, carbon-efficient investment decisions made earlier in a given time horizon may imply a more lenient carbon budget for day-to-day supply chain operations.

Further, at least one embodiment includes jointly optimizing emissions and profits across the supply-chain spatio-temporally. Such an embodiment can include recommending one or more interventions (based, for example, on counterfactual queries) that enable the joint optimization, and continuous updating of the intervention(s) depending on the resulting emissions and how they compare against the recommended budget for that time-scale and location.

By way merely of illustration, consider an example use case including a yearly carbon budget for a given enterprise over future n years, xᵢ, wherein i=1, 2, . . . , n. Accordingly, an example embodiment can include determining one or more strategic decisions such that a multi-year budget is met. For instance, such decisions can be related to total carbon emissions over n years≤Σᵢ xᵢ, given the carbon budget xᵢ for year i. Additionally, such an embodiment can include determining one or more tactical decisions such that a yearly budget is met. For instance, such decisions can be related to total carbon emissions in year i, Σⱼ yᵢⱼ≤xᵢ, as well as computing the corresponding optimal budgets yᵢⱼ for each quarter in year i. Also, such an embodiment can include generating and/or providing a carbon budget for a quarter j in year i, yᵢⱼ For instance, determining operational decisions such that the quarterly budget is met can be related to total carbon emissions in quarter j, Σₖ zᵢⱼₖ≤yᵢⱼ.

Accordingly, at least one embodiment includes using machine learning-based models (e.g., machine learning based emissions models and/or machine learning-based profit models) across multiple distinct levels (e.g., strategic, tactical, and operational) and/or time-scales with respect to at least one enterprise, as well as across different locations and/or geographies of the at least one enterprise. Such an embodiment can include, for at least a portion of the multiple levels and/or time-scales and at least a portion of the different locations and/or geographies, dynamically updating a carbon budget calendar over one or more given time horizons (e.g., weekly, quarterly, yearly, etc.) and for each location and/or geography. Such dynamically updated carbon budgets can then be used as input in determining, for example, one or more supply chain-related decisions. Such decisions can, for example, attempt to jointly optimize emissions reductions and enterprise profits, and can include recommendations across one or more time-scales and one or more locations in an attempt to ensure that carbon budgets are met.

In a situation wherein actual emissions, at any time and any location, differ from a recommended carbon budget, one or more embodiments can include using counterfactual querying to quantify sensitivity of machine learning-based profit model(s) and/or machine learning-based emissions model(s) to one or more decision variables. A counterfactual explanation can describe a causal situation in the form: “If X had not occurred, Y would not have occurred.” Accordingly, to contextualize, for example, “if the route A were not taken by the transportation vehicle(s), then carbon emissions would not have decreased by 20%.” Additionally or alternatively, such an embodiment can include re-learning, updating, and/or re-training the machine learning-based profit model(s) and/or machine learning-based emissions model(s) and/or re-optimizing one or more decision variables. Data that can be used to re-train and/or update the machine learning models can include, for example, historical economic cost and/or profit data, carbon emissions data associated with processes, products, assets, operations, etc., at different locations and time stamps, other contextual data such as weather forecasts, etc. For instance, a machine learning model can be trained to learn which discounts work best on different products at different locations based on past events such as previous years' holiday sales or at weather conditions (e.g., summer season, winter season, etc.). Such a machine learning model can be used to make decisions regarding economic costs and emissions for this year's holiday. Moreover, actual sales during this year's holiday can be used to re-train and/or update the model for future use.

As noted above and further detailed herein, one or more embodiments include determining decisions (e.g., optimal decisions) across different levels associated with a given enterprise. By way of illustration, consider vₛ, vₜ, vₒ, which can represent strategic, tactical and operational decision variables (continuous and discrete), respectively. As such, in an example embodiment, vₛ, vₜ, vₒ can serve as input to one or more machine learning-based models trained to determine decisions such as noted above. For example, machine learning-based profit-related models (e.g., yearlyProfit, quarterlyProfit, weeklyProfit, etc.) can be carried out as functions of vₛ, vₜ, vₒ trained on (along with other temporal and/or spatial features) past yearly profit data, quarterly profit data, weekly profit data, etc. Additionally or alternatively, machine learning-based emissions-related models (e.g., yearlyEmissions, quarterlyEmissions, weeklyEmissions, etc.) can be carried out as functions of vₛ, vₜ, vₒ trained on (along with other temporal and/or spatial features) past yearly emissions data, quarterly emissions data, weekly emissions data, etc.

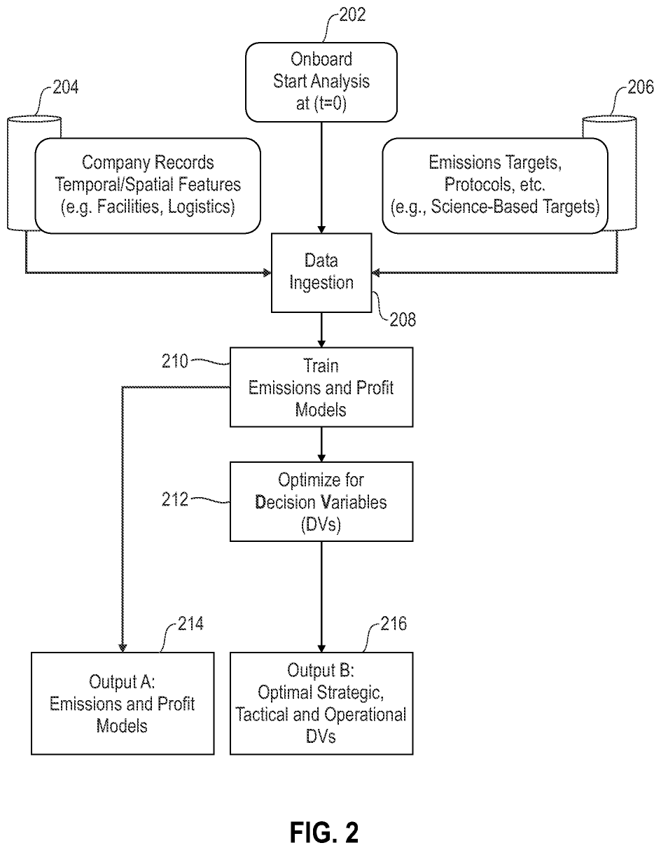

FIG. 2 is a diagram illustrating an initiation workflow, according to an example embodiment of the invention. By way of illustration, FIG. 2 depicts, in step 202, onboarding and/or starting analysis at t=0, e.g., year=quarter=week=0, with a total carbon budget C=Σᵢ xᵢ. Subsequently, step 208 includes data ingestion of historical data such as company and/or enterprise records 204 (e.g., temporal and/or spatial features such as facilities, logistics, etc.) and emissions-related data 206 (e.g., emissions targets and protocols). Data ingestion, in step 208, captures activities such as merging data from different supply chain nodes across different times and locations, and preliminary data-processing steps such as data-cleaning, augmentation, etc. Also, step 210 includes training yearly, quarterly, and/or weekly machine learning-based models (e.g., supervised machine learning models such as a regression model that is based on different techniques such as tree-based methods, neural networks, etc.) for profits and/or emissions using at least a portion of the historical data. Also, based at least in part on the trained machine learning-based models, the example workflow depicted in FIG. 2 includes generating output 214 which includes one or more emissions and/or profit models.

Additionally, based at least in part on the trained machine learning-based models, step 212 includes optimizing at least a portion of the machine-learning based models for one or more decision variables. Further, based at least in part on the optimizing carried out in step 212, the example workflow depicted in FIG. 2 includes generating output 216 which includes optimal strategic, tactical and operational decision variables (e.g., decisions that satisfy the expected carbon budgets across all years, quarters, weeks, etc.). Based at least in part on the output decision variables, at least one embodiment can also include computing optimal quarterly carbon budgets (yᵢⱼ) and weekly carbon budgets (zᵢⱼₖ).

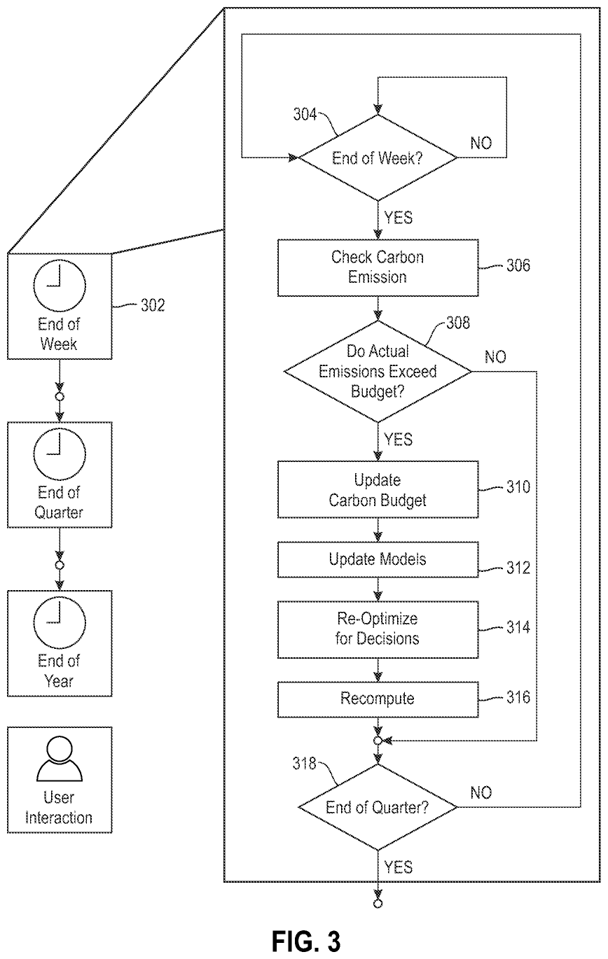

FIG. 3 is a diagram illustrating an end of week workflow 302, according to an example embodiment of the invention. By way of illustration, end of week workflow 302 includes determining, in step 304, if the end of a given week (e.g., of week k in quarter j of year i) has been reached. If yes, then step 306 includes determining and/or monitoring actual carbon emissions, [symbol] . Step 308 includes determining if the actual emissions exceed the carbon budget. If no, then the workflow proceeds to step 318 as described below. However, if the actual emissions exceed the carbon budget (i.e., if |zᵢⱼₖ− [symbol] ≥δ₁), then step 310 includes updating the remaining carbon budget for the remaining weeks of the quarter, yᵢⱼ=yᵢⱼ− [symbol] , step 312 includes updating machine learning-based weeklyEmissions model with observed emissions in week k, step 314 includes re-determining and/or re-optimizing one or more operational decisions (e.g., re-optimizing vₒ through counter-factual queries on the machine learning-based weeklyEmissions model), and step 316 includes re-computing an optimal zᵢⱼₖ for the remaining weeks in quarter j of year i. At least one embodiment can also include determining

$${max}_{{v}_{o}} Profit ( {\overline{v}}_{s} , {\overline{v}}_{t} , {v}_{o} ) ,$$

such that emissions (v̅ₛ, v̅ₜ, v̅ₒ)≤yᵢⱼ− [symbol] .

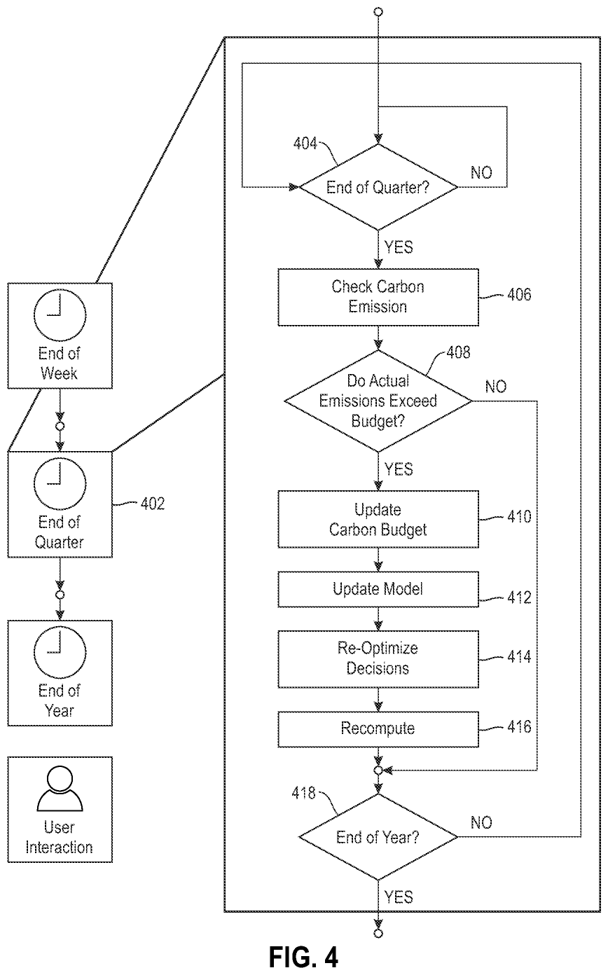

Subsequent to step 316 (and/or a negative determination in step 308), step 318 includes determining if the end of the quarter has been reached. If no (that is, the end of the quarter has not been reached), then the workflow returns to step 304. If yes (that is, the end of the quarter has been reached), then the workflow is continued, for example, as depicted in FIG. 4.

FIG. 4 is a diagram illustrating an end of quarter workflow 402, according to an example embodiment of the invention. By way of illustration, end of quarter workflow 402 includes determining, in step 404, if the end of a given quarter (e.g., of quarter j in year i) has been reached. If yes, step 406 includes determining and/or monitoring actual carbon emissions, [symbol] . Step 408 includes determining if the actual emissions exceed the carbon budget. If no, then the workflow proceeds to step 418 as described below. However, if the actual emissions exceed the carbon budget (i.e., if |yᵢⱼ− [symbol] |≥δ₂), step 410 includes updating the remaining carbon budget for the year (i.e., xᵢ=xᵢ− [symbol] ), step 412 includes updating the machine learning-based quarterlyEmissions model with observed emissions in quarter j, step 414 includes re-determining and/or re-optimizing one or more tactical decisions (vₜ) through counter-factual queries on the machine learning-based quarterlyEmissions model, and step 416 includes re-computing an optimal yᵢⱼ for the remaining quarters in year i. At least one embodiment can also include determining

$${max}_{{v}_{t}} Profit ( {\overline{v}}_{s} , {v}_{t} ) ,$$

such that emissions (v̅ₛ, vₜ)≤xᵢ− [symbol] .

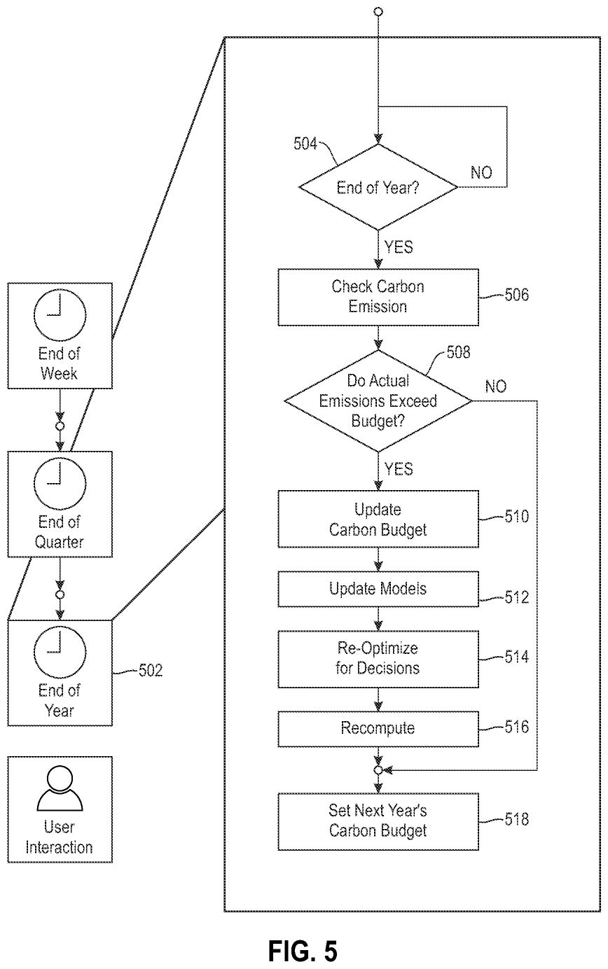

Subsequent to step 416 (and/or a negative determination in step 408), step 418 includes determining if the end of the year has been reached. If no (that is, the end of the year has not been reached), then the workflow returns to step 404. If yes (that is, the end of the year has been reached), then the workflow is continued, for example, as depicted in FIG. 5.

FIG. 5 is a diagram illustrating an end of year workflow 502, according to an example embodiment of the invention. By way of illustration, end of year workflow 502 includes determining, in step 504, if the end of a given year (e.g., year i) has been reached. If yes, step 506 includes determining and/or monitoring actual carbon emissions, \hat{x}_{ι}. Step 508 includes determining if the actual emissions exceed the carbon budget. If no, then the workflow proceeds to step 518 as described below. However, if the actual emissions exceed the carbon budget (i.e., if |xᵢ− [symbol] |≥δ₃), step 510 includes updating the remaining carbon budget, step 512 includes updating the machine learning-based yearlyEmissions model with observed emissions in year i, step 514 includes re-determining and/or re-optimizing one or more strategic decisions (vₛ) through counter-factual queries on the machine learning-based yearlyEmissions model for the remaining (n−i) years, and step 516 includes re-computing an optimal xᵢ for the remaining (n−i) years. At least one embodiment can also include determining

$${max}_{{v}_{s}} Profit ( {v}_{s} ) ,$$

such that Emissions (vₛ)≤Σᵢ xᵢ. Note also that, in one or more embodiments, targets for the remaining years will not be updated (instead they will be reset) at the end of each year.

Subsequent to step 516 (and/or a negative determination in step 508), step 518 includes setting the next year's carbon budget.

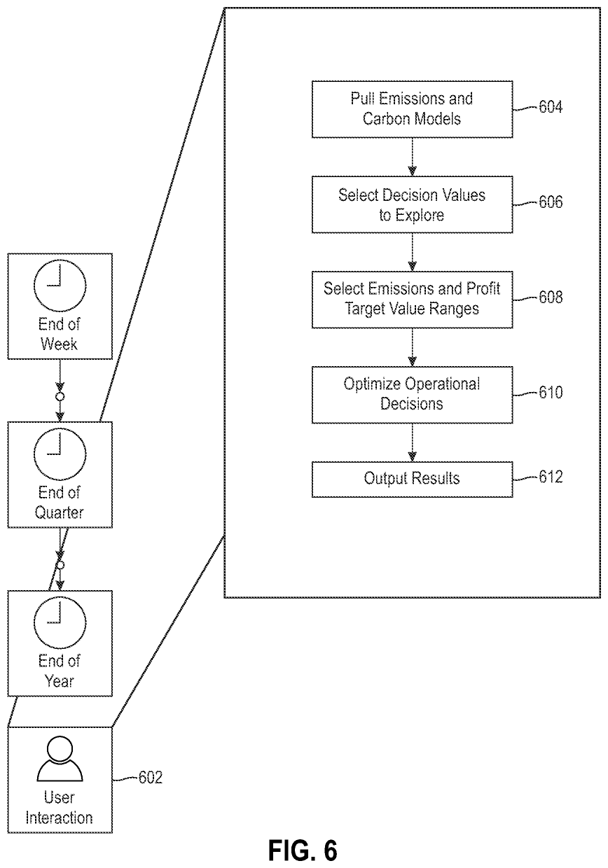

FIG. 6 is a diagram illustrating a counterfactual exploration workflow 602, according to an example embodiment of the invention. By way of illustration, counterfactual exploration workflow 602 includes pulling emissions and carbon models in step 604, and selecting decision values to explore in step 606. Additionally, step 608 includes selecting emissions and profit target value ranges, step 610 includes optimizing operational decisions, and step 612 includes outputting results.

In at least one embodiment, a user simulates various scenarios in a directed and/or exploratory manner. In a directed operation, the user selects one or more decision variables to set specific emissions and profit targets and/or ranges. In an exploratory operation, the system scans through multiple decision variable combinations in order to identify highly leveraged combinations to present to the user.

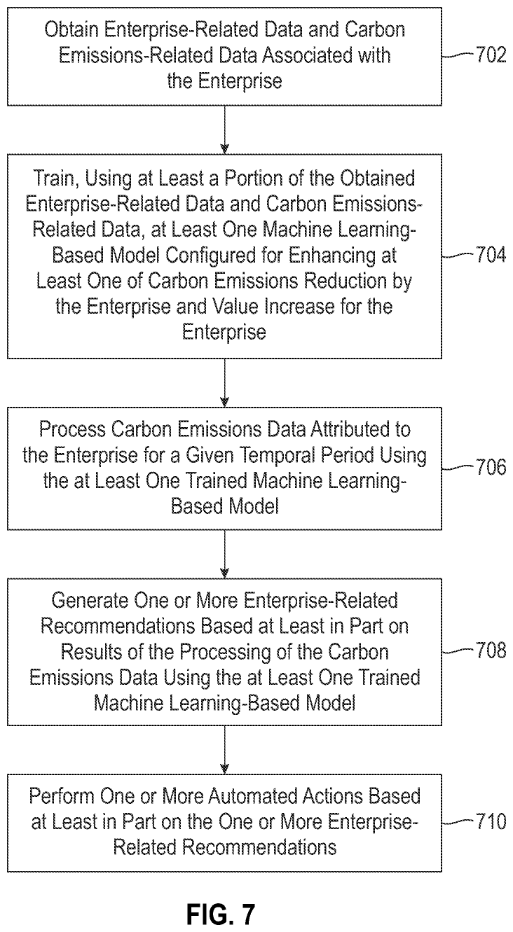

FIG. 7 is a flow diagram illustrating techniques according to an embodiment of the present invention. Step 702 includes obtaining enterprise-related data and carbon emissions-related data associated with the enterprise. In at least one embodiment, obtaining enterprise-related data includes obtaining one or more temporal features attributed to the enterprise and/or obtaining one or more spatial features attributed to the enterprise.

Step 704 includes training, using at least a portion of the obtained enterprise-related data and carbon emissions-related data, at least one machine learning-based model configured for enhancing at least one of carbon emissions reduction by the enterprise and value increase for the enterprise. Step 706 includes processing carbon emissions data attributed to the enterprise for a given temporal period (e.g., a week, a quarter, and/or a year) using the at least one trained machine learning-based model.

Step 708 includes generating one or more enterprise-related recommendations based at least in part on results of the processing of the carbon emissions data using the at least one trained machine learning-based model. In at least one embodiment, generating one or more enterprise-related recommendations includes generating one or more recommendations pertaining to at least one of one or more strategic decisions for the enterprise, one or more tactical decisions for the enterprise, and/or one or more operational decisions for the enterprise.

Step 710 includes performing one or more automated actions based at least in part on the one or more enterprise-related recommendations. In one or more embodiments, performing one or more automated actions includes retraining the at least one machine learning-based model using at least one of at least a portion of the carbon emissions data attributed to the enterprise for the given temporal period and at least a portion of the one or more enterprise-related recommendations. Additionally or alternatively, performing one or more automated actions can include outputting at least a portion of the one or more enterprise-related recommendations to at least one user associated with the enterprise, as well as adjusting one or more carbon emissions-related targets for the enterprise based at least in part on the one or more enterprise-related recommendations.

In one or more embodiments, software implementing the techniques depicted in FIG. 7 can be provided as a service in a cloud environment.

It is to be appreciated that “model,” as used herein, refers to an electronic digitally stored set of executable instructions and data values, associated with one another, which are capable of receiving and responding to a programmatic or other digital call, invocation, or request for resolution based upon specified input values, to yield one or more output values that can serve as the basis of computer-implemented recommendations, output data displays, machine control, etc. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer.

The techniques depicted in FIG. 7 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 7 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

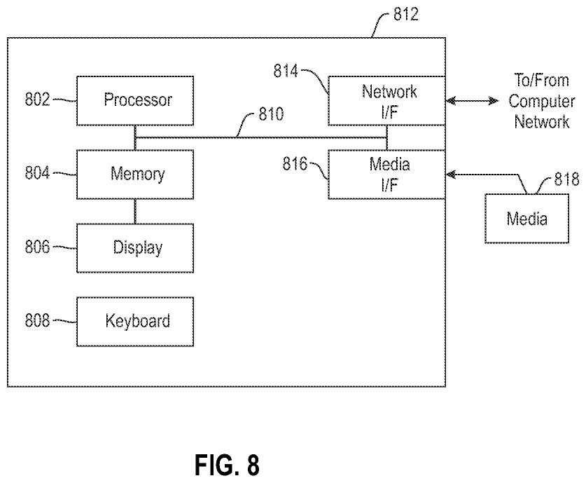

Additionally, an embodiment of the present invention can make use of software running on a computer or workstation. With reference to FIG. 8, such an implementation might employ, for example, a processor 802, a memory 804, and an input/output interface formed, for example, by a display 806 and a keyboard 808. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 802, memory 804, and input/output interface such as display 806 and keyboard 808 can be interconnected, for example, via bus 810 as part of a data processing unit 812. Suitable interconnections, for example via bus 810, can also be provided to a network interface 814, such as a network card, which can be provided to interface with a computer network, and to a media interface 816, such as a diskette or CD-ROM drive, which can be provided to interface with media 818.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 802 coupled directly or indirectly to memory elements 804 through a system bus 810. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 808, displays 806, pointing devices, and the like) can be coupled to the system either directly (such as via bus 810) or through intervening I/O controllers (omitted for clarity).

Network adapters such as network interface 814 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 812 as shown in FIG. 8) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 802. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

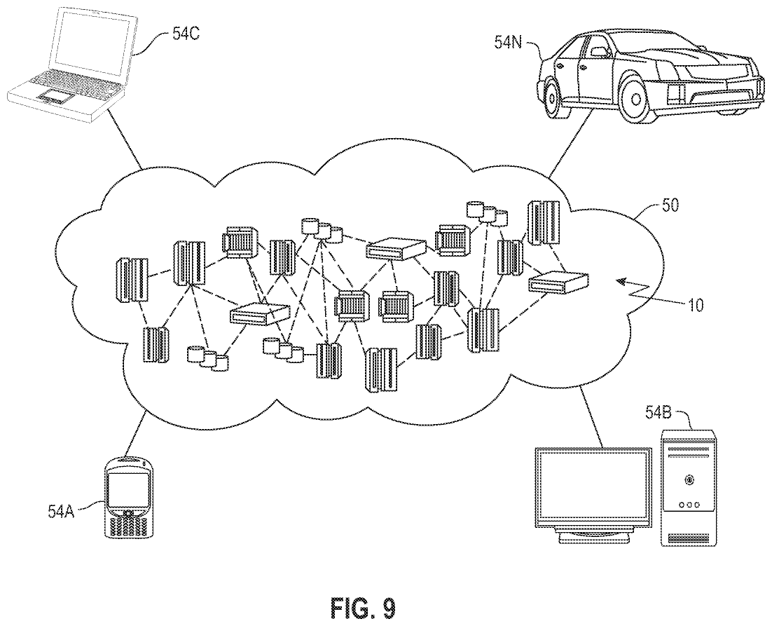

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

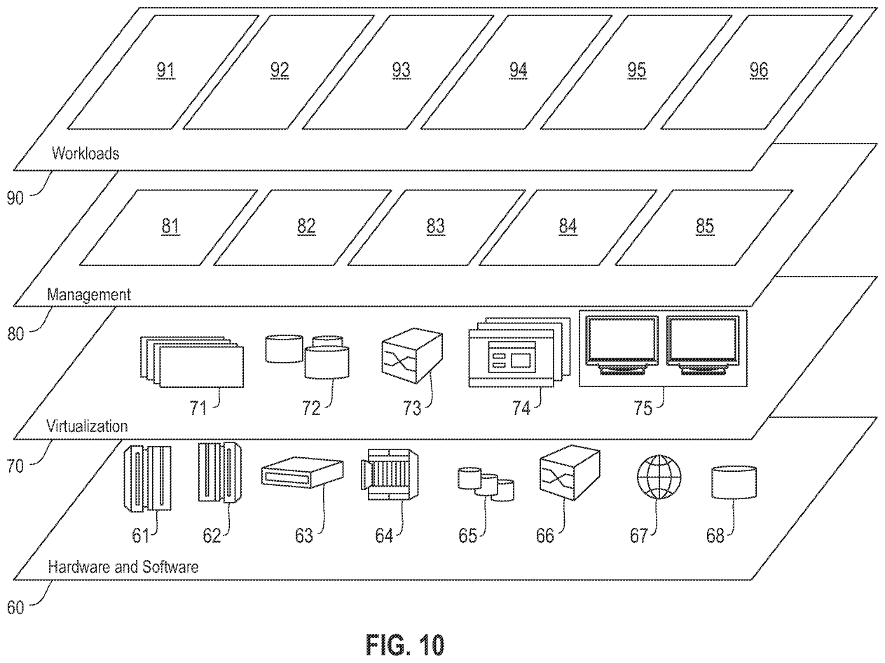

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and strategy enhancement 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, dynamically enhancing supply chain strategies based on carbon emission targets.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining enterprise-related data and carbon emissions-related data associated with the enterprise;
training, using at least a portion of the obtained enterprise-related data and carbon emissions-related data, at least one machine learning-based model configured for enhancing at least one of carbon emissions reduction by the enterprise and value increase for the enterprise;
processing carbon emissions data attributed to the enterprise for a given temporal period using the at least one trained machine learning-based model;
generating one or more enterprise-related recommendations based at least in part on results of the processing of the carbon emissions data using the at least one trained machine learning-based model; and
performing one or more automated actions based at least in part on the one or more enterprise-related recommendations;
wherein the method is carried out by at least one computing device.

2. The computer-implemented method of claim 1, wherein generating one or more enterprise-related recommendations comprises generating one or more recommendations pertaining to one or more strategic decisions for the enterprise.

3. The computer-implemented method of claim 1, wherein generating one or more enterprise-related recommendations comprises generating one or more recommendations pertaining to one or more tactical decisions for the enterprise.

4. The computer-implemented method of claim 1, wherein generating one or more enterprise-related recommendations comprises generating one or more recommendations pertaining to one or more operational decisions for the enterprise.

5. The computer-implemented method of claim 1, wherein performing one or more automated actions comprises retraining the at least one machine learning-based model using at least one of at least a portion of the carbon emissions data attributed to the enterprise for the given temporal period and at least a portion of the one or more enterprise-related recommendations.

6. The computer-implemented method of claim 1, wherein performing one or more automated actions comprises outputting at least a portion of the one or more enterprise-related recommendations to at least one user associated with the enterprise.

7. The computer-implemented method of claim 1, wherein performing one or more automated actions comprises adjusting one or more carbon emissions-related targets for the enterprise based at least in part on the one or more enterprise-related recommendations.

8. The computer-implemented method of claim 1, wherein obtaining enterprise-related data comprises obtaining one or more temporal features attributed to the enterprise.

9. The computer-implemented method of claim 1, wherein obtaining enterprise-related data comprises obtaining one or more spatial features attributed to the enterprise.

10. The computer-implemented method of claim 1, wherein the given temporal period comprises at least one of a week, a quarter, and a year.

11. The computer-implemented method of claim 1, wherein software implementing the method is provided as a service in a cloud environment.

12. A computer program product comprising a computer readable storage medium having program instructions embodied therewith, the program instructions executable by a computing device to cause the computing device to:
obtain enterprise-related data and carbon emissions-related data associated with the enterprise;
train, using at least a portion of the obtained enterprise-related data and carbon emissions-related data, at least one machine learning-based model configured for enhancing at least one of carbon emissions reduction by the enterprise and value increase for the enterprise;
process carbon emissions data attributed to the enterprise for a given temporal period using the at least one trained machine learning-based model;
generate one or more enterprise-related recommendations based at least in part on results of the processing of the carbon emissions data using the at least one trained machine learning-based model; and
perform one or more automated actions based at least in part on the one or more enterprise-related recommendations.

13. The computer program product of claim 12, wherein generating one or more enterprise-related recommendations comprises generating one or more recommendations pertaining to one or more strategic decisions for the enterprise.

14. The computer program product of claim 12, wherein generating one or more enterprise-related recommendations comprises generating one or more recommendations pertaining to one or more tactical decisions for the enterprise.

15. The computer program product of claim 12, wherein generating one or more enterprise-related recommendations comprises generating one or more recommendations pertaining to one or more operational decisions for the enterprise.

16. The computer program product of claim 12, wherein performing one or more automated actions comprises retraining the at least one machine learning-based model using at least one of at least a portion of the carbon emissions data attributed to the enterprise for the given temporal period and at least a portion of the one or more enterprise-related recommendations.

17. The computer program product of claim 12, wherein performing one or more automated actions comprises outputting at least a portion of the one or more enterprise-related recommendations to at least one user associated with the enterprise.

18. The computer program product of claim 12, wherein performing one or more automated actions comprises adjusting one or more carbon emissions-related targets for the enterprise based at least in part on the one or more enterprise-related recommendations.

19. The computer program product of claim 12, wherein obtaining enterprise-related data comprises obtaining at least one of one or more temporal features attributed to the enterprise and one or more spatial features attributed to the enterprise.

20. A system comprising:
a memory configured to store program instructions; and
a processor operatively coupled to the memory to execute the program instructions to:
obtain enterprise-related data and carbon emissions-related data associated with the enterprise;
train, using at least a portion of the obtained enterprise-related data and carbon emissions-related data, at least one machine learning-based model configured for enhancing at least one of carbon emissions reduction by the enterprise and value increase for the enterprise;
process carbon emissions data attributed to the enterprise for a given temporal period using the at least one trained machine learning-based model;
generate one or more enterprise-related recommendations based at least in part on results of the processing of the carbon emissions data using the at least one trained machine learning-based model; and
perform one or more automated actions based at least in part on the one or more enterprise-related recommendations.
